(19) United States
(12) Patent Application Publication
(10) Pub. No.: US 2003/0068119 A1
(43) Pub. Date: Apr. 10, 2003

(54) Mismatched mode field diameter device

(76) Inventors: Ping Xie, San Jose, CA (US); Kevin Zhang, Santa Clara, CA (US)

Correspondence Address: FISH & RICHARDSON P.C., 45 ROCKEFELLER PLAZA, SUITE 2800, NEW YORK, NY, 10111, US

(21) Appl. No.: 09/972,517

(22) Filed: Oct. 5, 2001

(51) Int. Cl. G02B 6/293; G02B 6/26

(52) U.S. Cl. 385/24; 385/47

(57) ABSTRACT

The present invention generally relates to fiber optical systems having mismatched mode field diameters. In order to reduce mode mismatched insertion loss in a system requiring coupling among fibers with mismatched mode field diameters, the core at the termination of each of the fibers having a mode field diameter (MFD) smaller than the largest mode field diameter in the system is thermally expanded to provide a MFD at the termination which matches the largest MFD. Embodiments of the invention include a novel pump signal combiner for fiber amplifiers.

### TECHNICAL FIELD OF THE INVENTION

The present invention relates to optical coupling techniques, and more particularly to optical beam coupling in optical systems employing optical fibers having mismatched mode field diameters.

### BACKGROUND OF THE INVENTION

Coupling of optical beams among optical fibers in optical networks typically involves some degree of insertion loss and a concomitant decrease in system efficiency. Insertion loss can be particularly high in optical systems employing optical fibers having mismatched mode field diameters. An example of such a system is a pump signal combiner for a fiber amplifier, such as an Erbium doped Fiber amplifier (EDFA) or a Raman amplifier. In erbium doped fiber amplification, an input signal, typically having a wavelength of around 1550 nm, is combined with a pump signal having a shorter wavelength and amplified by stimulated emission from excited electrons in erbium atoms in an erbium doped fiber (EDF). In a Raman amplifier, the input signal, typically having a wavelength of around 1300 nm or 1500 nm, is combined with a pump signal having a shorter wavelength and amplified by stimulated Raman scattering in a suitable optical fiber, for example a fiber of the same type as that carrying the input signal.

In a pump signal combiner for an erbium doped fiber amplifier (EDFA) as well as for a Raman amplifier, the separate input signal and pump signal may be carried by and launched from optical fibers having a mode field diameter (MFD) which differs from the MFD of the EDF or Raman amplifier fiber. The difference or mismatch in MFD between the amplification fiber, input signal fiber, and pump signal fiber reduces the output power and efficiency of the amplifier. Two prior art examples of a pump signal combiner for Raman amplifiers and EDFAs are shown schematically in FIGS. 1 and 2.

Referring to FIG. 1, an input signal 105 is launched from an input optical fiber 100, typically a single mode fiber having a MFD of about 10 μm, e.g. SMF-28, and collimated by lens 110. A pump signal 135 is launched from a pump optical fiber 140, which may be, for example, SMF-28 fiber, a CS-980 fiber having a MFD about half that of a SMF-28 fiber, or another suitable fiber, and collimated by lens 130. For an EDFA, input signal 105 typically has a wavelength of about 1550 nm, and pump signal 135 has a shorter wavelength, for example about 980 nm or 1480 nm. For a Raman amplifier, input signal 105 may have a wavelength of about 1300 nm or about 1500 to 1600 nm, and pump signal 135 has a shorter wavelength, for example about 1240 nm or 1450 nm. Pump wavelength division multiplexer (WDM) 120 combines signals 105 and 135 into an optical beam 145 carrying both signals by reflecting signal 105 and transmitting signal 135. Optical beam 145 is collimated by lens 110 and is incident on a termination of output fiber 150, which is typically an erbium doped fiber (for EDFA applications) or Raman amplifier fiber (for Raman amplifiers). The EDF typically has a smaller MFD to enhance signal gain, and in some cases its MFD is about 1 μm to 2 μm. For a distributed Raman amplifier, the Raman fiber is typically of the same type as the transmission (input) fiber. For a discrete Raman amplifier, the Raman fiber can have a significantly smaller MFD than the transmission fiber to enhance Raman gain. Because of the mismatch in MFD between the input fiber and pump fiber, on the one hand, and output fiber 150, on the other hand, a high insertion loss is suffered at the output fiber.

In a typical fiber amplifier application, the output of the pump signal combiner described above is coupled to a fiber amplifier. For example, referring to FIG. 1, output fiber 150 may be coupled, at a termination opposite the termination which receives optical beam 145, to a fiber amplifier (not shown). Optical beam 145 is then transmitted through output fiber 150 to the fiber amplifier.

Referring to FIG. 2(a), input signal 205 and pump signal 235 are combined to form optical beam 245 in the same manner as in FIG. 1. Like reference numbers in FIGS. 1 and 2 identify corresponding components. Output fiber 250, however, is a fiber of the same kind as fiber 200, with the same MFD. Fiber 250 is fusion spliced at splice joint 255 to an EDF or Raman amplifier fiber 260. A high splice insertion loss is suffered at the joint 255, as suggested by FIG. 2(b), which schematically shows a cross section of fibers 250 and 260. Fiber 250 has cladding 251, core 252, and MFD 253 (about 10 μm) while fiber 260 has cladding 261, core 262, and MFD 263 (about 1 μm to 2 μm). The mismatch in MFD at splice joint 255 is evident.

### SUMMARY OF THE INVENTION

The invention provides systems and methods for coupling optical signals among optical fibers, at least a portion of which have mismatched mode field diameters, whereby coupling loss due to mode mismatch among the fibers is reduced.

According to one aspect of the invention, a method is provided for combining optical signals. The method comprises providing a first optical fiber having a first core, a first termination, and a first mode field diameter (MFD) extending over a major portion. thereof, providing a second optical fiber having a second core, a second termination, and a second MFD extending over a major portion thereof, providing a wavelength division multiplexer (WDM) that transmits light of a first wavelength and that reflects light of a second wavelength, providing a third optical fiber having a third core, a third termination, and a third MFD extending over a major portion thereof, launching a first optical signal of the first wavelength from the first termination toward a first surface of the WDM opposite the first termination, launching a second optical signal of the second wavelength from the second termination toward a second surface of the WDM opposite the second termination, reflecting the first optical signal from the first surface of the WDM toward the third termination and transmitting the second optical signal through the WDM toward the third termination to combine the first and second signals into a combined signal which includes the first signal of the first wavelength and the second signal of the second wavelength, and receiving the combined signal at the third termination, wherein at least one of the first, second and third cores has been thermally expanded at its corresponding termination to match a largest of the first, second, and third mode field diameters.

According to another aspect of the invention, a device is provided for combining optical signals. The device comprises a first optical fiber having a first core, a first termination, and a first mode field diameter (MFD) extending over a major portion thereof, a second optical fiber having a second core, a second termination, and a second MFD extending over a major portion thereof, a wavelength division multiplexer (WDM) having a first surface facing the first termination and a second surface facing the second termination and that transmits light of a first wavelength and that reflects light of a second wavelength, and a third optical fiber having a third core, a third termination facing the first surface of the WDM, and a third MFD extending over a major portion thereof, wherein at least one of the first, second and third cores has been thermally expanded at its corresponding termination to match a largest of the first, second, and third mode field diameters.

According to yet another aspect of the invention, a system is provided for combining optical signals. The system comprises a first optical fiber having a first core, a first termination, and a first mode field diameter (MFD) extending over a major portion thereof, a second optical fiber having a second core, a second termination, and a second MFD extending over a major portion thereof, signal combining means optically coupled to the first and second optical fibers, and, a third optical fiber optically coupled to the signal combining means and having a third core, a third termination, and a third MFD extending over a major portion thereof, wherein at least one of the first, second and third cores has been thermally expanded at its corresponding termination to match a largest of the first, second, and third mode field diameters.

### BRIEF DESCRIPTION OF THE DRAWINGS

Embodiments of the invention will now be described by way of example with reference to the drawings in which:

FIG. 1 schematically shows a pump signal combiner for a Raman amplifier or EDFA typical of the prior art.

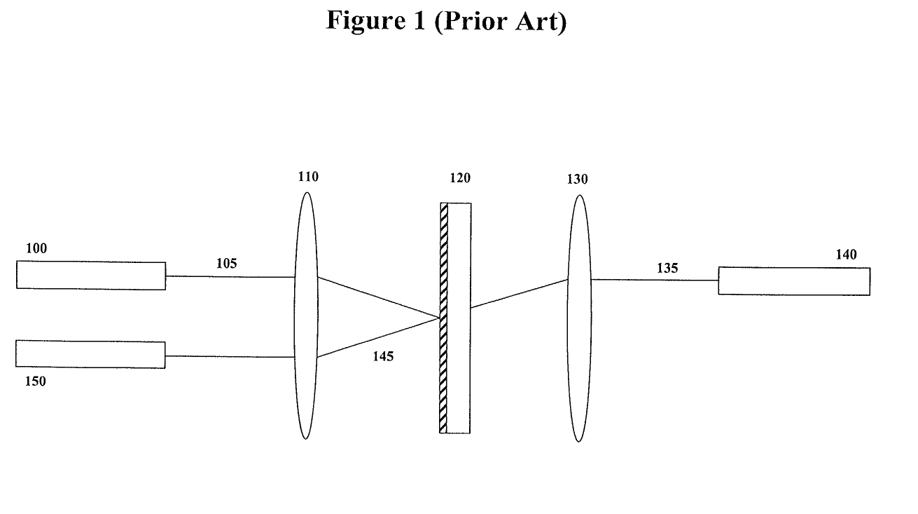

FIG. 2(a) schematically shows another pump signal combiner for a Raman amplifier or EDFA typical of the prior art.

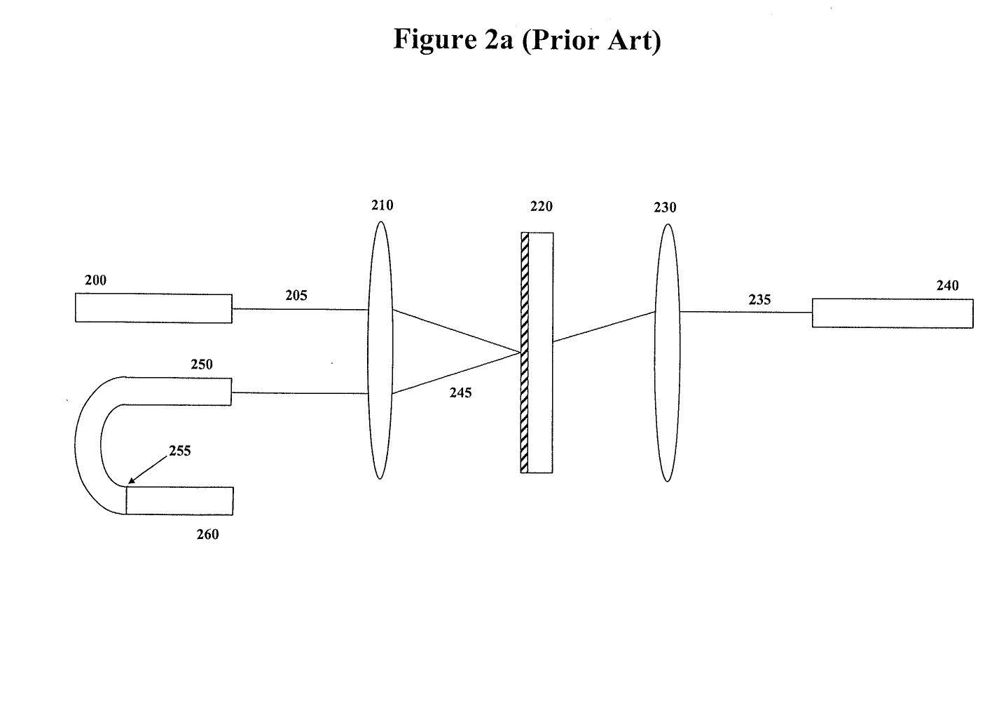

FIG. 2(b) schematically shows a cross section of the spliced output fiber of the amplifier of FIG. 2(a).

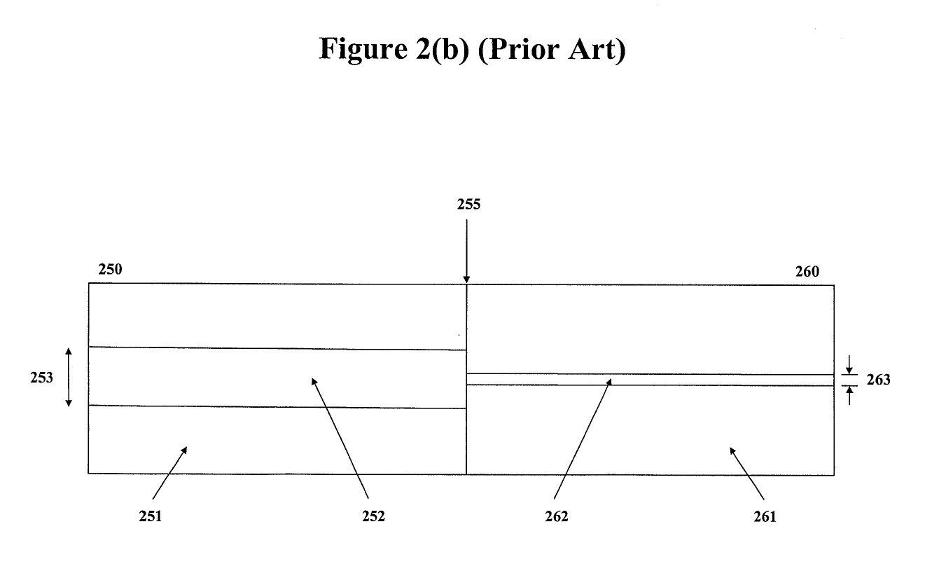

FIG. 3(a) schematically shows an embodiment of pump signal combiner for a Raman amplifier or EDFA.

FIG. 3(b) schematically shows a cross section of the output fiber of the pump signal combiner of FIG. 3(a).

### DETAILED DESCRIPTION OF THE PREFERRED EMBODIMENTS

The present invention generally relates to fiber optical systems which require coupling of optical beams among optical fibers having mismatched mode field diameters. According to an embodiment of the invention, first and second optical fibers are provided. The first optical fiber has a first termination, a first core, and a first mode field diameter (MFD). The second optical fiber has a second termination, a second core that has been thermally expanded at the second termination to match the first MFD, and a second MFD smaller than the first MFD extending over a major portion of the second fiber. The first and second fibers are disposed in relation to each other such that an optical signal transmitted through a first one of the first and second fibers and launched from a corresponding first one of the first and second terminations is received at a second one of the first and second terminations and transmitted through a corresponding second one of the first and second fibers.

This and other embodiments of the invention provide one-to-one imaging between fibers with reduced mode mismatched coupling loss. Coupling between the fibers may be achieved by a variety of methods, for example by direct transmission imaging or through any of a variety of optical components which may be inserted between fibers in an optical system, for example a wavelength division multiplexer, filter, circulator, switch, mirror, or the like. The principles of the embodiments of the invention described herein may be used to advantage in optical systems employing a plurality of optical fibers, wherein at least a portion of the plurality of fibers have mismatched mode field diameters.

Thermal expansion of the core of an optical fiber may be accomplished by heating a portion of the fiber employing methods well known in the art, for example as discussed in K. Shiraishi, T. Yanagi, and S. Kawakami, “Light-Propagation Characteristics in Thermally Diffused Expanded Core Fibers,” Journal of Lightwave Technology 11 (1993) 1584, and the references therein. Heating the optical fiber causes impurity atoms, introduced into the core of the fiber to give it a higher index of refraction than the surrounding cladding, to diffuse into the cladding, thereby increasing the diameter of the core and the mode field diameter. The extent to which the core may be expanded depends on the heating temperature and heat treatment time. Typically, the longer the heat treatment time, the more the core will be expanded. The core of the fiber is expanded to match a desired target value. The fiber may then be cleaved at a desired point along the previously heated portion of the fiber, yielding the desired core-expanded fiber termination. For example, the fiber may be cleaved at the center of the previously heated portion to obtain, by symmetry, two identical core-expanded fiber terminations. The core-expanded portion of the fiber typically extends several millimeters from the termination and gradually tapers over a few millimeters to the major portion of the fiber, which is characterized by a constant core diameter and constant MFD. A mode propagating in such thermally expanded core (TEC) fibers undergoes a mode-maintaining adiabatic transition in going from the major portion of the fiber to the core-expanded termination and vice versa.

Another embodiment of the invention is a pump signal or wavelength division multiplexing (WDM) combiner for an Erbium doped fiber amplifier (EDFA) or Raman amplifier employing optical fibers having mismatched mode field diameters. Typically, at least one of the three fibers in the pump signal combiner will have a MFD which is smaller than the MFD of one or both of the remaining fibers. For example, in a pump signal combiner for an EDFA, the MFD of the output fiber, which may be an EDF, is typically smaller than that of the signal fiber, while the MFD of the signal fiber is typically the largest and that of the pump fiber is equal to or smaller than that of the signal fiber. In such a case, a termination of the output fiber is thermally expanded to create a MFD at the termination which matches, that is, is at least as large as, the largest MFD, namely that of the signal fiber. If the pump fiber has a smaller MFD than the signal fiber, then a termination of the pump fiber may also be thermally expanded to match the signal fiber MFD, that is, expanded so that the MFD at the termination of the pump fiber is at least as large as the MFD of the signal fiber. If the pump signal fiber has a MFD equal to that of the signal fiber, no thermal expansion of the pump signal fiber is necessary. In the case of an exemplary pump signal combiner for a distributed Raman amplifier, the output fiber MFD is typically the same as that of the signal fiber, but the pump fiber may have a smaller MFD. In such a case, a termination of the pump fiber is thermally expanded to match the MFD of the signal and output fibers, so that the MFD at the termination of the pump fiber is at least as large as the MFD of the signal and output fibers. In the case of an exemplary pump signal combiner for a discrete Raman amplifier having a Raman fiber with a significantly smaller MFD than that of the signal fiber, a termination of the output fiber is thermally expanded to match that of the signal fiber, so that the termination of the output fiber has a MFD at least as large as that of the signal fiber. In these examples, an optical system having fibers with matched effective MFDs at one of their terminations is achieved, allowing one-to-one imaging among fibers, resulting in reduced system complexity and optimized fiber to fiber coupling.

The choice of fiber in a given application is typically affected by many system requirements such as dispersion, insertion loss, and non-linearity reduction. In addition to the aforementioned SMF-28 and CS-980 fibers and other suitable optical fibers, embodiments of the invention may employ a popular signal fiber recently introduced by Corning, the LEAF fiber, which has a larger MFD than the widely deployed SMF-28 fiber. The LEAF fiber's large MFD results in lower modal dispersion and reduced four wave mixing (fiber nonlinearity). Moreover, fibers having a larger MFD may be used to advantage in cases where it is desired to increase the power handling capability of a WDM combiner.

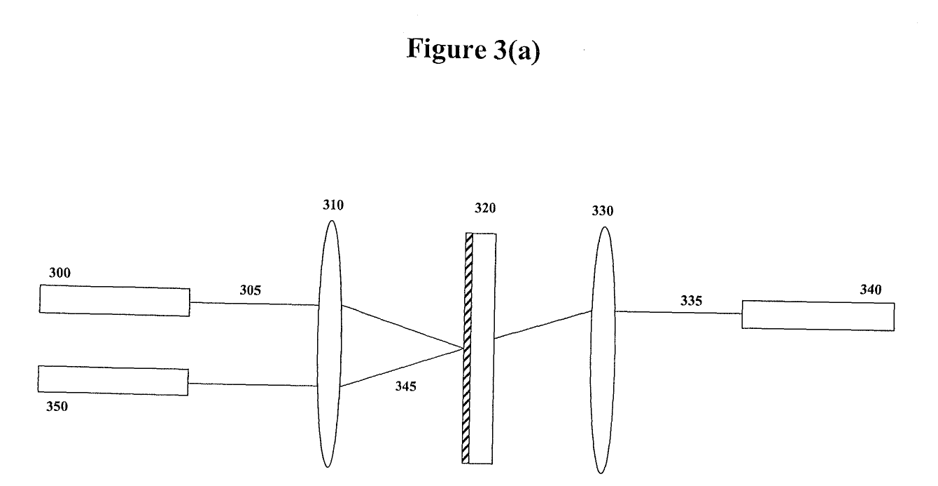

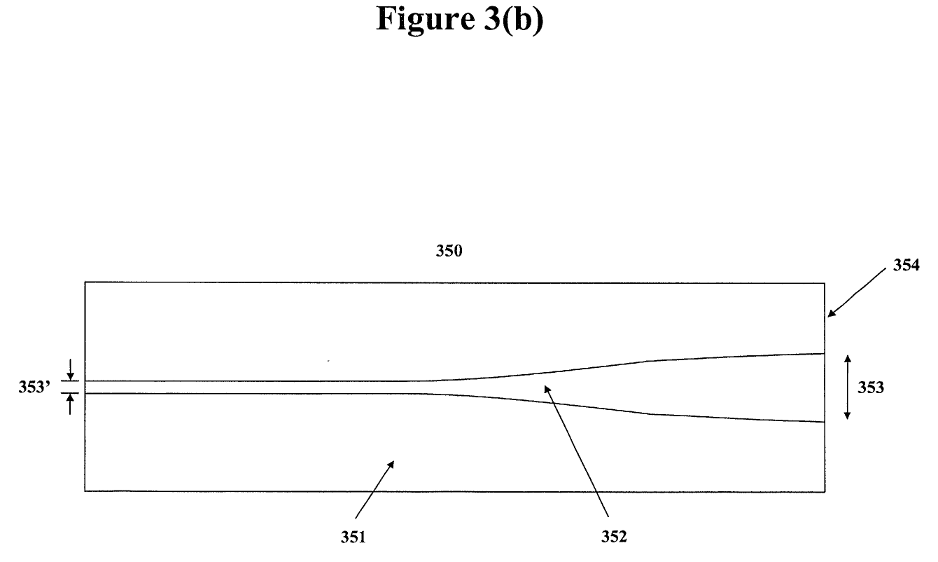

An exemplary embodiment of a pump signal combiner for an EDFA or discrete Raman amplifier system employing fibers with mismatched mode field diameters is shown in FIGS. 3(a) and 3(b). Referring to FIG. 3(a), an input signal 305 is launched from an optical fiber 300 suited to transmit an input signal, typically a single mode fiber having a MFD of about 10 /tm, e.g. SMF-28, and collimated by lens 310. Lens 310 may preferably be spaced from the termination of fiber 300 by a distance equal to the focal length of lens 310. A pump signal 335 is launched from a pump optical fiber 340 suited to transmit a pump signal, for example a SMF-28 or CS-980 fiber, and collimated by lens 330. Fiber 340 may be similar or identical to fiber 300, with a similar MFD. Lens 330 is preferably spaced from the termination of fiber 340 by a distance equal to the focal length of lens 330. The wavelengths of input signal 305 and pump signal 335 for the EDFA or Raman amplifier are as described previously. Pump wavelength division multiplexer (WDM) 320 combines signals 305 and 335 into an optical beam 345 carrying both signals by reflecting signal 305 and transmitting signal 335. Optical beam 345 is collimated by lens 310 and is incident on a termination of output fiber 350, which may be an erbium doped fiber (for use with an EDFA) or Raman amplifier fiber (for use with a discrete Raman amplifier) having a thermally expanded core at the termination.

WDM 320 may preferably be a thin film band splitter formed by applying a stack of dielectric thin film coating of suitable thickness and index of refraction to optical glass. The thickness and index of refraction of the dielectric coating stack is chosen so as to reflect signal 305 and transmit signal 335. WDM 320 may optionally be any suitable pump multiplexer, of which many examples will be evident to those skilled in the art, for example a periodic interleaver, which combines odd and even wavelength channels together. Examples of periodic interleavers include Mach-Zehnder interferometers and polarization based birefringent filters.

FIG. 3(b) schematically shows a cross section of a portion of fiber 350 with cladding 351 and core 352. The MFD decreases from a maximum value 353, for example about 10 μm, at the fiber termination 354, to a minimum value 353′, for example, about 1 μm to 2 μm, typical of the major portion of an EDF or discrete Raman amplifier fiber. The amount of thermal expansion of the core at the termination 354 of fiber 350 is chosen so as to match the MFD of the output fiber 350 to the larger of the MFDs of fibers 300 and 340. Other configurations of pump signal combiner for fiber amplifier systems will be evident to those skilled in the art. For example, the fiber 350 in FIG. 3(a) may have a MFD similar or equal to that of signal fiber 300, while the MFD of pump fiber 340 may be smaller. In such a case, a termination of fiber 340 is thermally expanded. In the case where all fibers have different MFDs, a termination of each of the two fibers with MFDs smaller than the largest MFD is thermally expanded to match the largest MFD.

In another embodiment, the output of the pump signal combiner described above is coupled to a fiber amplifier. For example, referring to FIGS. 3(a) and 3(b), output fiber 350 may be coupled, at a termination opposite termination 354, to a fiber amplifier (not shown). Optical beam 345 is then transmitted through output fiber 350 to the fiber amplifier.

Using the principles of the invention, high insertion losses in a WDM combiner employing fibers having mismatched MFDs may be significantly reduced. The scope of the invention is not limited to the specific components and configurations described herein, however, and the principles of the invention may also be applied to advantage in any application wherein it is desired to couple light among fibers with mismatched mode field diameters.

Various embodiments of the present invention have now been described. While these embodiments have been set forth by way of example, various other embodiments and modifications will be apparent to those skilled in the art. Accordingly, it should be understood that the invention is not limited to such embodiments, but encompasses all that which is described in the following claims.

What is claimed is:

1. A method of combining optical signals comprising:
providing a first optical fiber having a first core, a first termination, and a first mode field diameter (MFD) extending over a major portion thereof;
providing a second optical fiber having a second core, a second termination, and a second MFD extending over a major portion thereof;
providing a wavelength division multiplexer (WDM) that transmits light of a first wavelength and that reflects light of a second wavelength;
providing a third optical fiber having a third core, a third termination, and a third MFD extending over a major portion thereof;
launching a first optical signal of the first wavelength from the first termination toward a first surface of the WDM opposite the first termination;
launching a second optical signal of the second wavelength from the second termination toward a second surface of the WDM opposite the second termination;
reflecting the first optical signal from the first surface of the WDM toward the third termination and transmitting the second optical signal through the WDM toward the third termination to combine the first and second signals into a combined signal which includes the first signal of the first wavelength and the second signal of the second wavelength; and
receiving the combined signal at the third termination;
wherein at least one of the first, second and third cores has been thermally expanded at its corresponding termination to match a largest of the first, second, and third mode field diameters.

2. The method according to claim 1, wherein the at least one of the first, second and third cores has been thermally expanded at the corresponding termination to provide a tapered core decreasing in diameter from the corresponding termination toward the corresponding major portion.

3. The method according to claim 1, wherein the third fiber is an erbium doped fiber.

4. The method according to claim 1, wherein the second wavelength is shorter than the first wavelength.

5. The method according to claim 1, wherein the first and second fibers are single mode fibers.

6. The method according to claim 1, wherein the WDM is a thin film dielectric band splitter.

7. The method according to claim 1, further comprising:
providing a first collimating lens disposed between the first and third terminations and the first surface of the WDM; and
providing a second collimating lens disposed between the second termination and the second surface of the WDM.

8. The method according to claim 1, wherein the combined signal is transmitted through the third fiber to a fiber amplifier.

9. A device for combining optical signals comprising:
a first optical fiber having a first core, a first termination, and a first mode field diameter (MFD) extending over a major portion thereof;
a second optical fiber having a second core, a second termination, and a second MFD extending over a major portion thereof;
a wavelength division multiplexer (WDM) having a first surface facing the first termination and a second surface facing the second termination and that transmits light of a first wavelength and that reflects light of a second wavelength; and
a third optical fiber having a third core, a third termination facing the first surface of the WDM, and a third MFD extending over a major portion thereof;
wherein at least one of the first, second and third cores has been thermally expanded at its corresponding termination to match a largest of the first, second, and third mode field diameters.

10. The device according to claim 9, wherein the at least one of the first, second and third cores has been thermally expanded at the corresponding termination to provide a tapered core decreasing in diameter from the corresponding termination toward the corresponding major portion.

11. The device according to claim 9, wherein the third fiber is an erbium doped fiber.

12. The device according to claim 9, wherein the first and second fibers are single mode fibers.

13. The device according to claim 9, wherein the first and second mode field diameters are equal.

14. The device according to claim 9, wherein the first and third mode field diameters are equal.

15. The device according to claim 9, wherein the second and third mode field diameters are equal.

16. The device according to claim 9, wherein the WDM is a thin film dielectric band splitter.

17. The device according to claim 9, wherein the first, second, and third fibers and the WDM and disposed in relation to each other such that:
a first optical signal of the first wavelength launched from the first termination toward the first surface of the WDM is reflected from the first surface toward the third termination,
a second optical signal of the second wavelength launched from the second termination toward the second surface of the WDM is transmitted through the WDM toward the third termination and is combined with the reflected first signal into a combined optical signal which includes the first signal of the first wavelength and the second signal of the second wavelength, and
the combined optical signal is received at the third termination.

18. The device according to claim 17, wherein the combined optical signal is transmitted through the third fiber to a fiber amplifier.

19. The device according to claim 9, further comprising:
a first collimating lens disposed between the first and third terminations and the first surface of the WDM; and
a second collimating lens disposed between the second termination and the second surface of the WDM.

20. A system for combining optical signals comprising:
a first optical fiber having a first core, a first termination, and a first mode field diameter (MFD) extending over a major portion thereof;
a second optical fiber having a second core, a second termination, and a second MFD extending over a major portion thereof;
signal combining means optically coupled to the first and second optical fibers; and
a third optical fiber optically coupled to the signal combining means and having a third core, a third termination, and a third MFD extending over a major portion thereof;
wherein at least one of the first, second and third cores has been thermally expanded at its corresponding termination to match a largest of the first, second, and third mode field diameters.

21. The system according to claim 20, wherein the at least one of the first, second and third cores has been thermally expanded at the corresponding termination to provide a tapered core decreasing in diameter from the corresponding termination toward the corresponding major portion.

22. The system according to claim 20, wherein the third optical fiber is an erbium doped optical fiber.

23. The system according to claim 20, wherein the first and second fibers are single mode fibers.

24. The system according to claim 20, wherein the signal combining means is a thin film dielectric band splitter.

25. The system according to claim 20, wherein the signal combining means is a periodic interleaver.

26. The system according to claim 20, further comprising a fiber amplifier optically coupled to the third fiber.

27. The system according to claim 20, further comprising:
a first collimating lens disposed between and optically coupled to the first and third terminations and the signal combining means; and
a second collimating lens disposed between and optically coupled to the second termination and the signal combining means.
